(19) United States
(12) Patent Application Publication
(10) Pub. No.: US 2025/0154411 A1
(43) Pub. Date: May 15, 2025

(54) Method of Production of a Soil Conditioner and the Soil Conditioner Produced by the Method

(71) Applicants: agriCARBON s.r.o., Brno (CZ); Groown s.r.o., Vsestary (CZ); FERTICHAR S.R.O., Prerov (CZ)

(72) Inventors: Josef Marousek, Litvinovice (CZ); Ladislav Kolar, Ceske Budejovice (CZ); Otakar Strunecky, Ceske Budejovice (CZ); Jan Kana, Tabor (CZ)

(21) Appl. No.: 18/722,738

(22) PCT Filed: Jun. 20, 2022
(86) PCT No.: PCT/CZ2022/000028

§ 371 Date: Jun. 21, 2024

(30) Foreign Application Priority Data
Dec. 22, 2021 (CZ) PV 2021-592

(51) Int. Cl. C09K 17/16; C09K 101/00

(52) U.S. Cl. CPC C09K 17/16; C09K 2101/00

(57) ABSTRACT

A method of production of granular soil conditioner based on a mixture of biochar and organic fertilizer comprising the following steps:
Biochar mixing with animal excrements in a ratio of 1 part of biochar to 0.1 to 0.4 parts of the excrement dry matter, adding to the base of a mixture of soil bacteria belonging to at least two genera of the following: bacteria of the Rhizobia genus, nitrifying bacteria of the Azospirillum or Azotobacter genus, bacteria of the Pseudomonas genus, and bacteria of the Bacillus genus,
topping the bacteria-endowed base with water in the weight not more than double the weight of the bacteria-endowed base and letting the mixture ferment for at least 5 days,
draining off the excess water and drying the bacterial base so that the water content does not exceed 20% by weight,
adding a mixture of spores of fungi containing at least two of the group including Trichoderma, Arbuscular mycorrhizal fungi, Ectomycorrhizal fungi to the base-bacteria compound in a total quantity corresponding to 0.2 to 1% of the dry matter weight of the base-bacteria compound.

### TECHNICAL FIELD

The invention concerns a means for improvement of soil properties, for plant fertilising and nutrition.

### BACKGROUND ART

The vast majority of farmland is farmed in intensive ways that aim to maximise crop yields, regardless of the consequences for soil health. The massive use of mineral fertilisers and plant protection products is causing a major loss of micro- and macro-organisms in the soil. Yet their role in creating natural soil fertility is irreplaceable. As a result of the lack of organisms in the soil, cultivated plants are completely dependent on artificial fertilisers.

The application of mineral fertilisers is associated with the frequent repeated driving of agricultural machinery across the field, which negatively affects the physical properties of the soil. The soil layers are compacted. This negatively affects the ability of rainwater to soak into the soil and leads to massive water erosion.

This negative trend in agricultural practice can be reversed by adopting gentle practices that supply the soil with organic matter as a source of energy for soil micro-organisms and material that improves soil structure. Such material should allow applications with standard agricultural technology used in intensive farming.

Microgranular fertilizers have been commonly used in agriculture since the latter half of the 20th century. They enable more efficient crop establishment through more accurate nutrient dosing, better use of soil protection products and other agrochemicals. Today's farming technology allows microgranular fertilisers to be applied at virtually any, yet precise, distance from the seed-directly into the seedbed to the seed. This increases the efficiency of the use of active substances. The interaction of seed and fertiliser allows a “starter effect” to be triggered at the beginning of the growing season, which enables future crops to quickly develop a robust root system. This allows them to make better use of spring moisture, quickly build up leaf area and thereby suppress competing weeds. Granular fertiliser increases crop yields and also reduces the cost of weed control applications.

In the production of microgranular fertiliser, minerals such as sepiolite, which belong to raw materials from non-renewable natural resources, are used as basic substances. Their production is energy-intensive. And yet the availability of the nutrients contained in such microgranular fertilisers for plant nutrition is problematic.

Biochar is a charred type of biomass. It is used, among other things, as a soil conditioner to improve physical properties of soil and its natural fertility. Biochar is usually obtained by thermal reduction of biomass at temperatures between 45° and 800° C. Its composition depends on the material from which it is made. It usually contains between 50 and 90% by weight of stable carbon and, in addition to carbon, usually about 1% by weight of phosphorus, 2% by weight of potassium, 6% by weight of calcium and 1.5% by weight of magnesium.

The use of biochar as part of soil conditioners and granular fertilisers is known from the state of the art.

CN 105646047 (A) discloses a water- and steam-proof biochar-based compound fertilizer and a method for preparation thereof. The granular fertiliser consists of the following ingredients, stated in parts by weight: 15 parts of biochar powder, 30 parts of urea, 30 parts of monoammonium phosphate, 22 parts of potassium sulphate and 20 to 30 parts of water, with a maximum of 1 part of binders, including starch in gelatine form. The desired characteristic of this fertiliser, i.e. the gradual infiltration of nutrients into the soil, is given by the binder, which is in the nature of a potting compound. The biochar content is relatively low and its ability to slowly release the absorbed inorganic nutrients into soil is not utilised.

CN112390691 (A) discloses a soil conditioner consisting of bamboo charcoal powder and an organic fertiliser, wherein the weight ratio of the bamboo charcoal powder to the organic fertiliser is 1:2.4 to 1:14. The way in which the two main raw materials are combined, and the soil micro-organisms are not mentioned.

CN107573163 (A) describes an acidic soil conditioner for plant nutrition. It consists of a mixture of base material and auxiliary material, wherein the base material consists of 45 to 65 parts by weight of brewer's malt, 40 to 60 parts of peat soil, 40 to 50 parts of Chinese medicine residues, 35 to 45 parts of soybean meal powder, 30 to 40 parts of straw powder, 25 to 35 parts of edible fungi residues, 24 to 36 parts of pineapple paste, 20 to 30 parts of apple paste, 15 to 25 parts of silkworm excrements, 10 to 16 parts of proteolytic enzymes, 4 to 8 parts of Azotobacter, 5 to 9 parts of Rhizobia, 4 to 6 parts of potassium-decomposing bacteria, 6 to 8 parts of cellulolytic bacteria, 4 to 6 parts of antibiotic-producing bacteria and 60 to 80 parts of water with which the previous ingredients are mixed and fermented, the fermentation process not being defined. Then, the auxiliary materials are added, namely 40 to 60 parts of earthworm excrements, 25 to 35 parts of biochar residues, 20 to 30 parts of urea, 18 to 28 parts of vegetable ash, 10 to 20 parts of lime powder, 10 to 20 parts of urea-iron complex and 10 to 20 parts of chelated zinc. The described complex contains large amounts of defined types of organic matter and bacteria, which are co-fermented.

This mixture, apart from bacteria, only contains labile organic matter, and so during fermentation neither the nutrients nor the colonising bacteria can be fixed into a fixed structure in which the nutrients and bacteria can be bound or able to colonise the root systems. In addition, in at least some cases, the components used are generally difficult to get or require significant energy inputs. Also, the contribution of carbon from biomass is minor and therefore the application of this conditioner cannot be expected to improve soil structure.

The objective of the present invention is to provide a method of producing a bio-based organic fertilizer in the form of microgranules which, when released slowly, ensure the bioavailability of organic nutrients from the earliest stages of plant development. The purpose is for the microgranule fertilizer to replace basic fertilization to a large extent, not only to promote growth in the early stages of vegetation.

### DISCLOSURE OF THE INVENTION

The present task addresses a method of producing a granular soil conditioner based on a mixture of biochar and organic fertilizer, wherein the conditioner is endowed with bacteria, mycorrhizal fungi and a myco-parasitic fungus.

The method comprises the following steps:
mixing the biochar obtained by thermal reduction of plant biomass or animal bones with animal excrements at a weight ratio of 1 part of biochar to 0.1 to 0.4 part of excrement dry matter, adding to this base a mixture of soil bacteria including at least two of the following genera:
   bacteria of the Rhizobia genus,
   nitrification bacteria of the Azospirillum or Azotobacter genus,
   bacteria of the Pseudomonas genus,
   bacteria of the Bacillus genus,
the dry matter weight of which, at a concentration of CFU 10⁹, being 0.2 to 0.5% of the weight of the dry matter in the base,
topping the bacteria-endowed base up with water with a weight of not more than double the weight of the bacteria-endowed base and letting the mixture ferment for at least 5 days,
thereupon draining the excess water off and drying the base with bacteria for the water content to be reduced to not more than 20% by weight, after which a mixture of spores of fungi belonging to at least two representatives of the groups Trichoderma, Arbuscular mycorrhizal fungi, Ectomycorrhizal fungi is added to the mixture of the base with bacteria in a total quantity corresponding to 0.2 to 1 wt % of the dry matter weight of the mixture of the base with bacteria,
thereupon mixing the thus prepared compound thoroughly.

Preferably, a mixture of soil bacteria of the Azospirillum or Azotobacter genus and the Bacillus genus may be added to the base, wherein a mixture of spores of myco-parasitic fungi such as the Trichoderma or Pythium genera, and arbuscular fungi such as the Glomus genus, or ectomycorrhizal fungi such as the Pisolithus, Scleroderma or Rhizopogon genera are added to the base-bacteria mixture.

Alternatively, fungi forming ericoid mycorrhizae with heather plants are added.

A particularly preferable method consists in adding a mixture of soil bacteria to the base in a weight ratio of
25% of the Rhizobia genus bacteria,
25% of nitrification bacteria of the Azospirillum or Azotobacter genus,
25% of the Pseudomonas genus bacteria,
25% of the Bacillus genus bacteria,
   whereupon the base endowed with bacteria is supplemented before fermentation with water equal in weight to that of the base with bacteria, and whereupon a mixture of fungal spores is added to the mixture of base with bacteria in the following weight ratio: 50% of Arbuscular mycorrhizal fungi, 25% of Ectomycorrhizal fungi and 25% of Myco-parasitic fungi such as Trichoderma.

The base may preferably be complemented with 0.1 to 0.3 parts of a mineral fertiliser.

In the manufacture of the conditioner in granular form, starch in an amount of 4 to 6% of the dry matter weight of the base-bacteria mixture is mixed with water at boiling point temperature, and this starch suspension is added to the base-bacteria mixture after cooling, and this mixture is granulated in a granulator to form granules with a diameter of 1 to 5 mm.

The said task is also fulfilled by a soil conditioner based on a mixture of biochar and organic fertiliser produced by any of the above methods, comprising a mixture of soil bacteria belonging to at least three of the following groups: Rhizobia, Azospirillum or Azotobacter, Pseudomonas and Bacillus, and further comprising a mixture of fungal spores belonging to at least three of the following groups: Arbuscular mycorrhizal fungi, Ectomycorrhizal fungi, Myco-parasitic fungi.

In a preferred embodiment the conditioner takes the form of granules with starch as the binder.

Thanks to the presence of biochar, the conditioner acts as a soil conditioner, which contributes to improving water and air management and soil structure. An important component of the conditioner is soil biota in the form of rhizobacteria belonging to several strains that fix airborne nitrogen, make organic nutrients available to plants and protect them against pests and stress. In addition to bacteria, the conditioner also contains spores of mycorrhizal fungi that live in symbiosis with the plant roots. They extract carbon from them and in return provide nutrients in an optimally available form. Both of these components of the soil biota ensure that the natural soil fertility is restored, which in effect makes it possible to reduce or even completely eliminate additional fertilisation with artificial fertilisers. The conditioner, through the use of biochar, contributes synergistically to carbon sequestration and is therefore a tool for so-called Pyrogenic Carbon Capture and Storage. The carbon in biochar was originally part of the CO2 molecule in the air, which was broken down by the process of photosynthesis, after which the carbon was stored in the body of the plant from whose biomass the biochar was derived.

### BRIEF DESCRIPTION OF DRAWINGS

The results of the application of the conditioner made according to the method of the present invention will be documented in the drawings, in which

FIG. 1 is a table showing the results of incubation vessel experiments performed with samples of the conditioner made according to the method described in the following examples, and

FIG. 2 is a graph showing the development of mycorrhizae on wheat root systems when these samples are applied.

### MODES FOR CARRYING OUT THE INVENTION

### Example 1

The biochar obtained by thermal reduction of softwood at 550° C. was pulverized into particles of 1 to 15 mm in size.

For the production of the fertiliser, a mixture was prepared as described above with the following composition by weight
1 part of biochar,
0.2 part of vermicompost leach concentrate (Vermi-tea)
0.02 part of a mixture of bacteria of the Rhizobia genus, the Azotobacter genus, the Pseudomonas genus and the Bacillus genus, each represented in equal parts
0.05 part of spores of the Glomus sp. (50%), and the Trichoderma sp. (50%)

The mixture of biochar, vermicompost (excreta of earthworms) and bacterial mixture was topped up with water in a weight ratio of 1:1.5 and fermented for seven days. Subsequently, excess water was drained off and after cooling, a suspension of 0.1 part of starch mixed with boiling water in a 1:1 weight ratio and mycorrhizal fungal spores were added. After thorough mixing, the mixture was granulated on a granulation press into granules with a diameter of 3 mm. The sample was labelled as MicroCHAR+Vermitea.

### Example 2

The biochar obtained by thermal reduction of softwood at 550° C. was pulverized into particles of 1 to 15 mm in size.

For the production of the fertiliser, a mixture was prepared as described above with the following composition by weight
1 part of biochar,
0.4 part of poulter excrement dry matter,
0.02 part of a mixture of bacteria of the Rhizobia genus, the Azotobacter genus, the Pseudomonas genus and the Bacillus genus, each represented in equal parts
0.05 part of spores of the Glomus sp. (50%), and the Trichoderma sp. (50%)

The mixture of biochar, poultry excrements and bacterial mixture was topped up with water in a weight ratio of 1:1.5 and fermented for seven days. Subsequently, excess water was drained off and after cooling, a suspension of 0.1 part of starch mixed with boiling water in a 1:1 weight ratio and mycorrhizal fungal spores were added. After thorough mixing, the mixture was granulated on a granulation press into granules with a diameter of 3 mm. The sample was labelled as MicroCHAR Organic.

### Example 3

The biochar obtained by thermal reduction of softwood at 550° C. was pulverized into particles of 1 to 15 mm in size.

For the production of the fertiliser, a mixture was prepared as described above with the following composition by weight
1 part of biochar,
0.2 part of poultry excrement dry matter
0.2 part of ammonium phosphate (NH₄)₃PO₄)
0.02 part of a mixture of bacteria of the Rhizobia genus, the Azotobacter genus, the Pseudomonas genus and the Bacillus genus, each represented in equal parts
0.05 part of spores of the Glomus sp. (50%), and the Trichoderma sp. (50%)

The mixture of biochar, poultry excrements and bacterial mixture was topped up with water in a weight ratio of 1:1.5 and fermented for seven days. Subsequently, excess water was drained off and 0.2 part of ammonium phosphate was added. After cooling, a suspension of 0.1 part of starch mixed with boiling water in a 1:1 weight ratio and mycorrhizal fungal spores were added. After thorough mixing, the mixture was granulated on a granulation press into granules with a diameter of 3 mm. The sample was labelled as MicroCHAR Mineral.

To assess the effects of biochar alone in the conditioner, a soil conditioner was prepared by the following method:

The biochar obtained by thermal reduction of softwood at 550° C. was pulverized into particles of 1 to 15 mm in size.

For the production of the fertiliser, a mixture was prepared as described above with the following composition by weight
1 part of biochar,
0.02 part of a mixture of bacteria of the Rhizobia genus, the Azotobacter genus, the Pseudomonas genus and the Bacillus genus, each represented in equal parts
0.05 part of Arbuscular mycorrhizal fungal spores (50%), Trichoderma (50%)

After cooling, a suspension of 0.2 part of starch mixed with boiling water in a 1:1.5 weight ratio and mycorrhizal fungal spores were added. The resulting mixture was subsequently granulated on a granulation press into granules with a diameter of 3 mm. The sample was labelled as MicroCHAR.

Conditioner samples produced by the described methods were subsequently tested in laboratories to determine nutrient availability, both by the Mehlich Ill certified method and by incubation vessel experiments. The Mehlich Ill methodology is a certified methodology for sampling the content of substances in soil according to Annex 2 to Decree No 275/1998 Coll.

The testing by the Mehlich Ill method yielded the results shown in tables 2 and 3:

TABLE 2
Contents of bio-available macro-elements measured by the Mehlich III method.

| | Macro elements | | | | | |
|---|---|---|---|---|---|---|
| | P | K | S | Ca | Mg | Na |
| | (g/kg) | (g/kg) | (g/kg) | (g/kg) | (g/kg) | (g/kg) |
| MicroCHAR | 7.52 ± 1.12 | 4.75 ± 0.29 | 3.54 ± 0.44 | 15.8 ± 1.2 | 0.31 ± 0.04 | 1.31 ± 0.17 |
| MicroCHAR + Mermitea | 5.40 ± 0.59 | 3.85 ± 0.22 | 2.17 ± 0.25 | 10.6 ± 0.8 | 0.27 ± 0.04 | 1.39 ± 0.18 |
| MicroCHAR Mineral | 14.1 ± 7.5 | 7.07 ± 11.3 | 3.36 ± 7.11 | 2.63 ± 3.52 | 1.52 ± 2.76 | 0.55 ± 0.30 |
| MicroCHAR Organic | 0.58 ± 0.06 | 29.2 ± 3.7 | 17.2 ± 2.1 | 9.46 ± 0.96 | 6.80 ± 0.83 | 1.27 ± 0.17 |

TABLE 3
Contents of selected bio-available micro-elements measured by the Mehlich III method.

| | Micro elements | | | | | | |
|---|---|---|---|---|---|---|---|
| | B | Mn | Bu | Al | Fe | Sr | Zn |
| | (mg/kg) | (mg/kg) | (mg/kg) | (mg/kg) | (mg/kg) | (mg/kg) | (mg/kg) |
| MicroCHAR | 50.1 ± 2.9 | 0.94 ± 0.08 | 12.8 ± 0.8 | 17.6 ± 1.4 | 14.2 ± 2.5 | 9.24 ± 1.22 | 3.57 ± 0.36 |
| MicroCHAR + Mermitea | 41.0 ± 0.4 | 1.60 ± 0.14 | 15.3 ± 0.4 | 16.9 ± 0.8 | 16.7 ± 2.4 | 5.72 ± 0.82 | 4.71 ± 0.22 |
| MicroCHAR Mineral | 8.96 ± [symbol] | 337 ± 231 | 1.56 ± 7.44 | 4.87 ± 9.73 | 16.1 ± 24.0 | 14.8 ± 25.1 | 32.9 ± 9.5 |
| MicroCHAR Organic | 10.9 ± 1.5 | 501 ± 90 | 17.9 ± 2.1 | 23.5 ± 3.3 | 57.6 ± 7.4 | 52.3 ± 7.6 | 53.5 ± 6.1 |

[symbol]

indicates data missing or illegible when filed

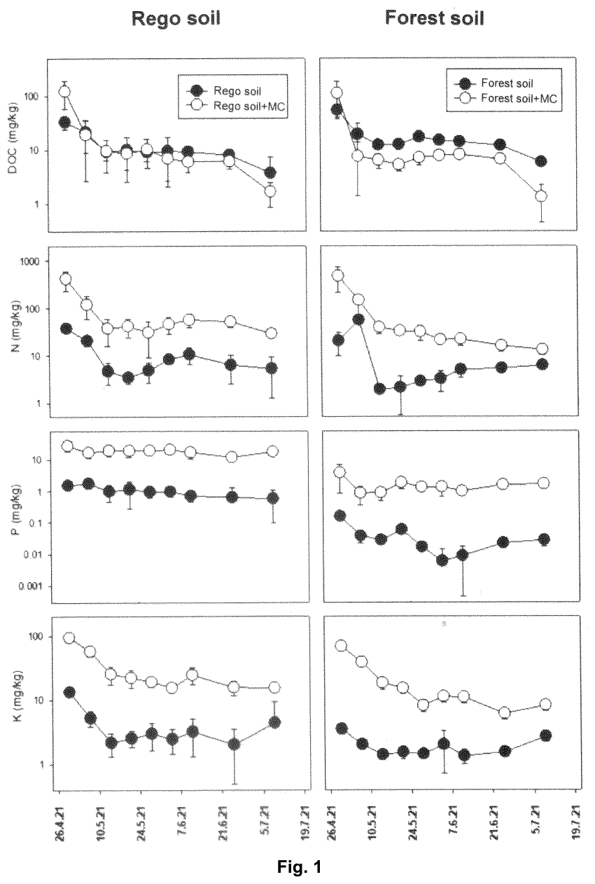

Subsequently, an incubation experiment was performed in which the conditioner prepared according to Example 1 was applied to the test containers together with two types of problematic soils-see the tables in FIG. 1. The sub-tables show diagrams of the uptake of each nutrient from the two soil types. The diagrams compare the results of the samples in which the conditioner is applied with control soil samples. Two types of problematic soils with a lack of organic matter and therefore low retention capacity and reduced nutrient content were used. They were agricultural soils from the Polabí region-Rego soil (with sand fraction content above 2 mm≈85%), and Forest soil (the mineral horizon) from around the Jevany municipality, respectively.

The sub-tables show the measurement dates on the x-axis and the mass of the individual elements N, P, K taken from the soil between measurements on the y-axis, where DOC is the amount of leached carbon. Therein, the lines with solid circles refer to the soil samples with the applied conditioner and the lines with empty circles to the control samples.

The results of cumulative extraction of individual nutrients show that during the period of about 2 months of the incubation, in the case of the treated agricultural Rego soil and the treated Forest soil, about 8 times more nitrogen and potassium and 11 times and 15 times more N and K, respectively, were extracted. For phosphorus there was a 30-fold increase in the case of Rego soil and even a 98-fold increase in the case of Forest soil. For the other macro-nutrients, the increase was between two and 12 times.

Further testing of the conditioner was carried out in the form of field trials in the season of 2021. Applications to spring wheat and maize were tested, each crop in three repetitions with fertiliser variants (MicroCHAR mineral, MicroCHAR organic and MicroCHAR). The conditioner was always applied at a rate of 80 kg per hectare during sowing. No fertiliser or protectant was applied during the vegetation period.

Effect recalculation to hectare yields

| | Overall dry matter weight | | Grain weight | |
|---|---|---|---|---|
| | Mean per area [g] | Recalculation to hectare [t] | Mean per area [g] | Recalculation to hectare [t] |
| PC | 1126.14 | 7.508 | 488.72 | 3.258 |
| PB | 1310.41 | 8.736 | 574.11 | 3.827 |
| PS | 1226.67 | 8.178 | 556.57 | 3.710 |
| PO | 1316.23 | 8.775 | 597.15 | 3.981 |
| KC | 1008.39 | 6.723 | 134.62 | 0.897 |
| KB | 1082.80 | 7.219 | 118.40 | 0.789 |
| KS | 1207.16 | 8.048 | 158.11 | 1.054 |
| KO | 1198.55 | 7.990 | 153.08 | 1.021 |

C Controls
B MICROCHAR
S MICROCHAR mineral
O MICROCHAR organic
For maize the weight of whole corncobs is shown

For all variants studied, plant dry matter and grain yields were at the level of high yields in organic farming.

The fertilizer was also analysed for the purpose of determining the levels of important elements, and the soil was similarly analysed after harvest to determine changes in the available nutrient content. It was found that the organic carbon content of the soil increased significantly after MicroCHAR mineral application and that the soil contained high levels of all forms of nitrogen. The MicroCHAR organic type in turn supplied the soil with high amounts of available potassium, calcium and magnesium. Compared to the untreated control, the soil supply of most of the important nutrients also increased after the growing season.

Furthermore, the available nutrient content of the conditioner samples was investigated in comparison with their condition after percolation (leasing). Percolation is the process of continuous flow of solvent through a sample on a filter.

2 g of the fertiliser (MicroCHAR, MicroCHAR mineral+, MicroCHAR organic+) were placed on a filtration paper for quantitative analysis of KA 2 and substances were extracted from the samples, by slow pouring of 10 mL of a solvent (distilled water) on them, into a 15 mL

| | | Ca | K | Mg | Na | P | S | Zn | TC | NPDC | TN | TN |
|---|---|---|---|---|---|---|---|---|---|---|---|---|
| MicroCHAR-titrate + percolation | pH | mg/L | mg/L | mg/L | mg/L | mg/L | mg/L | mg/L | mg/L | mg/L | mg/L | mg/L |
| MicroCHAR | [symbol] | [symbol] | [symbol] | [symbol] | [symbol] | [symbol] | [symbol] | [symbol] | [symbol] | [symbol] | [symbol] | [symbol] |
| MicroCHAR mineral+ | [symbol] | [symbol] | [symbol] | [symbol] | [symbol] | [symbol] | [symbol] | [symbol] | [symbol] | [symbol] | [symbol] | [symbol] |
| MicroCHAR organic+ | [symbol] | [symbol] | [symbol] | [symbol] | [symbol] | [symbol] | [symbol] | [symbol] | [symbol] | [symbol] | [symbol] | [symbol] |
| MicroCHAR [symbol] | [symbol] | [symbol] | [symbol] | [symbol] | [symbol] | [symbol] | [symbol] | [symbol] | [symbol] | [symbol] | [symbol] | [symbol] |
| MicroCHAR mineral + percolation | [symbol] | [symbol] | [symbol] | [symbol] | [symbol] | [symbol] | [symbol] | [symbol] | [symbol] | [symbol] | [symbol] | [symbol] |
| MicroCHAR organic + percolation | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

After the application of the MicroCHAR mineral fertiliser, the organic carbon content in the soil increased significantly. This fertiliser variant contains large amounts of all forms of nitrogen and is suitable as a nitrogen source. The MicroCHAR organic variant contains a high proportion of potassium, calcium and magnesium. A combination of both variants seems ideal.

The last factor observed was the development of mycorrhizal colonization of the roots of treated crops. The mycorrhizal colonization method determines the relative abundance of mycorrhizal fungi in a microscopic preparation of plant roots.

Wheat roots grown in soil treated with the conditioning samples were prepared using a standardized procedure. A magnification of 400× was used to view the stained roots spread on a microscope slide. Fields of view with visible mycorrhizal formations in the roots (arbuscules, vesicles, mycorrhizal fungal hyphae) were identified as positive. Significance or p-value methodology was used to evaluate the results-see https://en.wikipedia.org/wiki/P-value. The colonization result from the control sample was assigned a p-value of 0.05 (5%). The quantity and frequency of mycorrhizal formations detected in all three compared variants were evaluated by the so-called chi-squared test by the mathematical R software.

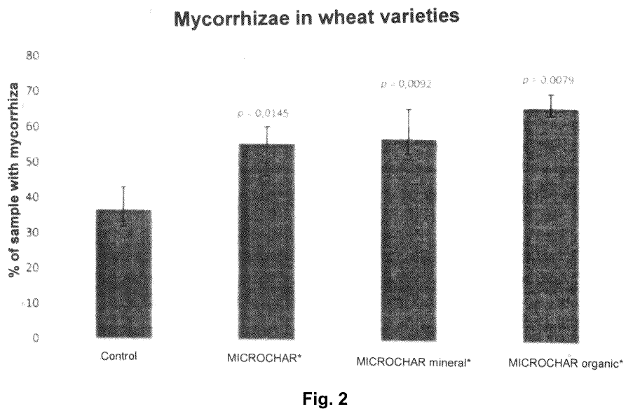

The development of mycorrhiza on the root systems of wheat grown in soil with the applied conditioner is shown in the diagram in FIG. 2.

All three samples show an increase in root colonization with a probability level equal to certainty. The best results were obtained with the application of the MicroCHAR organic variant. However, all three fertilizer variants tested significantly increased the formation of symbiosis with the native mycorrhizal population in the field soil compared to the control.

1. A method of production of a granulated soil conditioner based on a mixture of biochar and organic fertiliser, wherein the conditioner is endowed with bacteria, mycorrhizal fungi and myco-parasitic fungus, wherein the method comprises:
mixing the biochar obtained by thermal reduction of plant biomass or animal bones with animal excrements in the weight ratio of 1 part of biochar to 0.1 to 0.4 part of the excrement dry matter, mixing to this base a compound of soil bacteria including at least two of the group of:
Rhizobia genus bacteria,
nitrification bacteria of the Azospirillum or Azotobacter genus,
Pseudomonas genus bacteria, and
Bacillus genus bacteria,
wherein the weight of their dry matter at the concentration of CFU 10⁹ being 0.2 to 0.5% of the base dry matter weight,
topping the bacteria-endowed base up with water in the weight of not more than double the weight of the bacteria-endowed base and letting it ferment for at least 5 days,
draining off the excess water and drying the base with bacteria for the water content not to exceed 20 wt %, thereupon adding to the base-bacteria compound a mixture of fungal spores including at least two of the group of: Trichoderma, arbuscular mycorrhizal fungi, ectomycorrhizal fungi in a total amount corresponding to 0.2 to 1% of the base-bacteria compound dry matter weight, and
thereupon mixing the thus prepared mixture profoundly.

2. The method according to claim 1, wherein a mixture of soil bacteria of the Azospirillum or Azotobacter genus and the Bacillus genus is added to the base, whereupon a mixture of fungal spores of the myco-parasitic fungi such as Trichoderma or Pythium, and arbuscular fungi such as the Glomus genus, or ectomycorrhizal fungi, such as the Pisolithus, Scleroderma or Rhizopogon genera, or, alternatively, fungi forming ericoid mycorrhizae, is added to the base-bacteria compound.

3. The method according to claim 1, wherein a mixture of soil bacteria is added to the base in the following weight ratio:
25% of the Rhizobia genus bacteria,
25% of nitrification bacteria of the Azospirillum or Azotobacter genus,
25% of the Pseudomonas genus bacteria, and
25% of the Bacillus genus bacteria,
whereupon the bacteria-endowed base is topped up with water in the weight identical to the weight of the base with bacteria before fermentation, and further whereupon a mixture of fungal spores is added to the base with bacteria in the following weight ratio: 50% of Arbuscular mycorrhizal fungi, 25% of Ectomycorrhizal fungi and 25% of Myco-parasitic fungi, such as Trichoderma.

4. The method according to any of claim 1, wherein 0.1 to 0.3 part of mineral fertiliser is added to the base.

5. The method according to any of claim 1, wherein starch in the quantity of 4 to 6% of the base-bacteria compound dry matter weight is mixed with water at the boiling point temperature and this starch suspension, after cooling, is mixed to the base with bacteria and the base-bacteria-starch-mycorrhizal fungi compound is granulated in a granulator into the form of granules with a diameter of 1 to 5 mm.

6. A soil conditioner based on a mixture of biochar and organic fertiliser produced by the method according to claim 1, characterized wherein the conditioner contains a mixture of soil bacteria including at least three of the following group: Rhizobia, Azospirillum or Azotobacter, Pseudomonas and Bacillus, and the conditioner further contains a mixture of fungal spores including at least three of the following group: Arbuscular mycorrhizal fungi, Ectomycorrhizal fungi, and Myco-parasitic fungi.

7. The soil conditioner according to claim 6, wherein the conditioner is in the form of granules with starch as a binder.
